(19) United States
(12) Patent Application Publication
(10) Pub. No.: US 2004/0220687 A1
(43) Pub. Date: Nov. 4, 2004

(54) Device and method for transmitting, receiving and processing audio control signals in information systems

(76) Inventors: Thomas Klotz, Pullach (DE); Robert Eiblmeier, Munchen (DE)

Correspondence Address: WILLIAM COLLARD, COLLARD & ROE, P.C., 1077 NORTHERN BOULEVARD, ROSLYN, NY, 11576, US

(21) Appl. No.: 10/484,367

(22) PCT Filed: Jul. 19, 2002
(86) PCT No.: PCT/DE02/02674

(30) Foreign Application Priority Data
Jul. 20, 2001 (DE) 10135463.0

(51) Int. Cl. G06F 17/00

(52) U.S. Cl. 700/94

(57) ABSTRACT

The invention relates to a device for transmitting, receiving and processing digital audio signals which are supplied to the individual loud speaker units (4) by means of a common data bus (7). The supply of the units (4) by the data bus (7) is thus divided, the data is modulated according to the supply voltage in order to reduce the number of lines and so that the power input can be supplied centrally and monitoring and redundance, as required in security related systems, can be acquired by simple means, since only one part of the power supply must be monitored and embodied in a redundant manner.

The present invention relates to a device and a method for transmitting, receiving, and processing audio control signals in information systems, particularly with an information system that is suitable for selecting and distributing audio information at the loudspeaker in receiver-specific manner.

Such information systems are known in the state of the art, from the American patent U.S. Pat. No. 5,406,634. This known information system contains a so-called intelligent loudspeaker unit, which is controlled and supplied with digital data. The intelligent loudspeaker unit has a digital signal processor (DSP), which supplies the audio data in agreement with the control data. In this connection, the digital audio data are converted into digital analog signals, using a D/A converter, and amplified in analog manner. The digital audio data are passed to a data bus, using a time multiplexer. In this connection, specific information data intended for each individual audio channel are assigned to this channel, so that each loudspeaker unit can select its specific assigned information from the large number of the total data flow, and passes it on to the loudspeaker in analog manner. This so-called intelligent loudspeaker unit furthermore has a mixer that mixes fixed files with one another, so that the stored, newly incoming data can be mixed with one another.

Another method for distributing audio information over a large area is known from WO 96/29779. In this method, a large number of loudspeakers is used, which are set up at different locations. The individual loudspeaker units are individually supplied with audio information, which is transmitted by a central unit (CPU). The function of the individual components, particularly the loudspeaker unit, is transmitted by the CPU and controlled by means of a signal.

The other loudspeaker systems known in the state of the art, which are used for providing audio in public spaces such as airports, train stations, stadiums, or commercial buildings, are frequently connected in analog manner, by way of copper lines, with amplifiers that are spatially separated from the loudspeaker and are switched ahead of them, for reasons of security technology. These amplifiers, in turn, have control devices switched ahead of them, by way of which the audio signals can be equalized and adjusted in level. Other control devices that are switched ahead of them switch the different audio signals, generally by means of switching relays, to the individual loudspeaker paths. In these systems, each individual loudspeaker or each group of loudspeakers that is controlled with a common signal must have an amplifier with the control electronics assigned to it, in fixed manner, which has the result that free switching of the loudspeakers to different signal paths is only possible with significant technical effort.

It is felt to be a disadvantage, in these previously known methods and the electronics required for them, that the electronics require a significant amount of space and have a high weight. Often, these devices are concentrated in a small space, thereby resulting in great thermal stress. As a consequence of this, the electronics generally have to be set up remote from the actual loudspeaker, thereby resulting in long line paths between the control electronics and the power electronics, and the loudspeaker.

In order to reduce the power losses over long distances between the amplifier and the loudspeaker in such systems, in the state of the art, the audio signals at the amplifier output are first transformed to a higher voltage, using transformers, and brought back to the original level again at the loudspeaker, also using transformers, which has the result that each loudspeaker unit needs its own transformer.

If such systems are used in security-relevant areas, e.g. for evacuation measures from publicly accessible spaces, additional measures for emergency situations are required, in order to bridge the possible failure of the central power electronics or control electronics and the resulting failure of entire groups of loudspeakers. For this purpose, parallel signal paths with their own power electronics and control electronics are set up, which are separate from the power electronics and control electronics that are designed for normal operation and, if necessary, can be switched onto the path that has been damaged in the emergency, by means of relays. This method and the electrical devices required for it are costly, on the one hand, and too complicated in technical terms, on the other hand. One of the decisive disadvantages that all of the previously known methods and systems have in common is the relative high expenditure of energy, which is frequently the cause of uncontrollable problems.

Therefore it is the task of the present invention to make available an audio information system that serves to provide information to a large number of persons and is simple in its handling and inexpensive in its production.

This task is accomplished with the characterizing features of the main claims.

The method, according to the invention, for transmitting, receiving, and processing signals of an information system consisting of a central unit that receives, transmits, and controls signals digitally and/or in analog manner, and at least one loudspeaker unit having at least one loudspeaker, and at least one data bus, is characterized in that all of the loudspeaker units are supplied and controlled by the central unit, whereby the control data are modulated onto the supply voltage.

In this connection, it is advantageous that the signals in the data bus are transmitted at a low electric power and are subjected to signal processing directly at the loudspeaker, in a single module of a signal processing unit, which produces high acoustical power and quality.

Furthermore, it is advantageous to install a first control device in a module, which monitors the status of the loudspeaker unit and the switching electronics, and transmits the status to the central unit.

Another advantageous embodiment can be seen in that a second control device evaluates the incoming control signals from the data bus in the central unit in receiver-specific manner and converts them to receiver-specific signals.

In this connection, it is advantageous that a predetermined number of different audio signals and control signals is transmitted by means of a common data bus.

Furthermore, it is advantageous to transmit the control signals and control data in wireless manner, whereby the wireless data are transmitted in data-compressed manner, by means of a certain bandwidth (15 kBaud).

It is furthermore advantageous to use the data format on the basis of RS 485 signals, because in this way, inexpensive interface modules can be selected from a large number of available drivers.

It is furthermore important and advantageous to monitor the entire signal flow, for which purpose a high-frequency signal is transmitted along with the data flow, which lies above the human hearing range, and monitors the function of all the components in the signal flow, such as the signal processor, end stage of the loudspeaker and, in particular, the loudspeakers, etc.

Another advantage lies in the fact that the control data are transmitted in real time.

In certain cases, it can be advantageous that the individual local loudspeaker stations are brought together in groups and that the volume of the individual loudspeakers or loudspeaker groups is automatically adjusted to the noise level of the surroundings, or adjusted by means of remote control.

The devices according to the invention for the audio system for transmitting, receiving, and processing information data of an information system having a central unit that receives, transmits, and controls signals digitally and/or in analog manner, having one loudspeaker unit having at least one loudspeaker, and at least one data bus, is characterized in that all of the loudspeaker units are supplied and controlled by the central unit, whereby the data are modulated onto the supply voltage.

In this connection, it is advantageous to switch a support capacitor in parallel with the loudspeaker unit, on the input side, from which a certain amount of energy can be taken in the case of power peaks.

It is furthermore advantageous that the power amplification for the loudspeaker, which is operated in analog manner, is carried out using a digital power amplifier, whereby conversion of the digital signal into the analog range ahead of the amplifier is eliminated, and therefore significant costs are saved.

The digital end stage furthermore has the advantage of a significantly improved degree of effectiveness in comparison with an analog end stage. In this way, not only are the energy costs reduced, but also the waste heat of the loudspeaker unit is clearly reduced. This eliminates large cooling bodies, and the component can be designed in clearly more compact and effective manner.

It is advantageous that the loudspeaker unit, which is directly arranged at the loudspeaker, selects the signals coming in from the data bus, processes them digitally, and only converts them into analog signals at the loudspeaker.

Another advantage consists of the fact that at least one control device that monitors the status of the loudspeaker unit and the switching electronics transmits this status to the central unit by way of the data bus.

It is also advantageous that a control device is provided that evaluates the control signals that come into the central unit, individually for each loudspeaker, and passes the results to a processor (PC).

This is important and advantageous in security-relevant systems, in particular, in which monitoring of the end stages and of the loudspeakers is required. Because of the heat development of the end stages and the mechanical movement in the loudspeakers, these are the main components having the greatest risk of failure.

Since, in the case of security-relevant systems, each unit must be provided with a power source that is carried out redundantly and monitored, it is possible to implement this, if at all, only at very great effort and expense. Every power supply (up to one power supply per loudspeaker) must be carried out redundantly and monitored. In most cases, monitoring requires additional lines to the central unit, since the assessment of errors must usually take place there.

It is therefore advantageous for the invention that power is supplied to all the loudspeaker units from a central unit. For this purpose, the power is also distributed by way of the data bus. The data are modulated onto the supply voltage, in order to reduce the number of lines. In this way, the power can be supplied in central manner, and monitoring and redundancy, as they are required in security-relevant systems, can be achieved with simple means, since only one power supply has to be monitored and carried out redundantly.

Since transmission formats such as MADI are frequently used in the state of the art, and special and expensive interface modules (TAXI) must be used for this, on the one hand, and on the other hand, this is a format that is designed for 64 audio channels with a predetermined resolution (24 bits per value) in time multiplex, it is only in the rarest cases, in practice, that all the channels are used, since high data rates and special cables having a length limited to a maximum must be used for this. Therefore it is advantageous to use a data format on the basis of RS 485 signals. In this way, inexpensive interface modules can be selected from a large family of available drivers. The number of channels in the time multiplex method, as well as the resolution of the values (bit per value) can be adapted to the requirements, in each instance, in the present invention. Therefore inexpensive lines that guarantee a maximum transmission length can be optimized using simple means.

### In the following, the invention will be explained in greater detail, using drawings. These show:

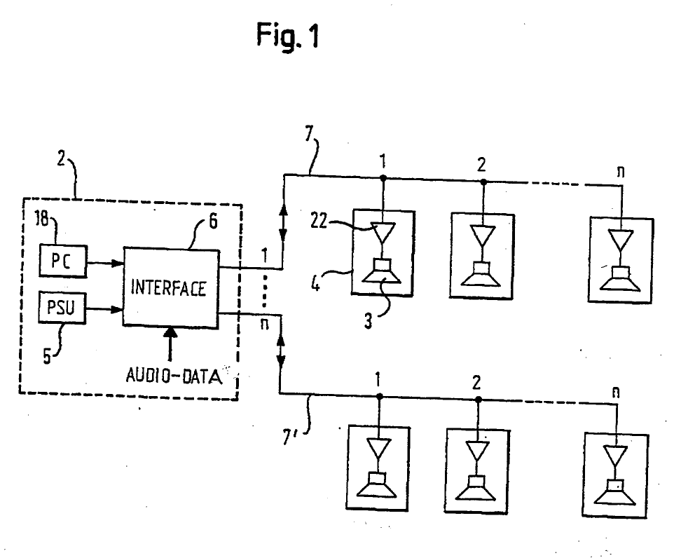

FIG. 1: a fundamental view of the audio and control system (1) according to the invention, with the individual modules (2, 12, 20);

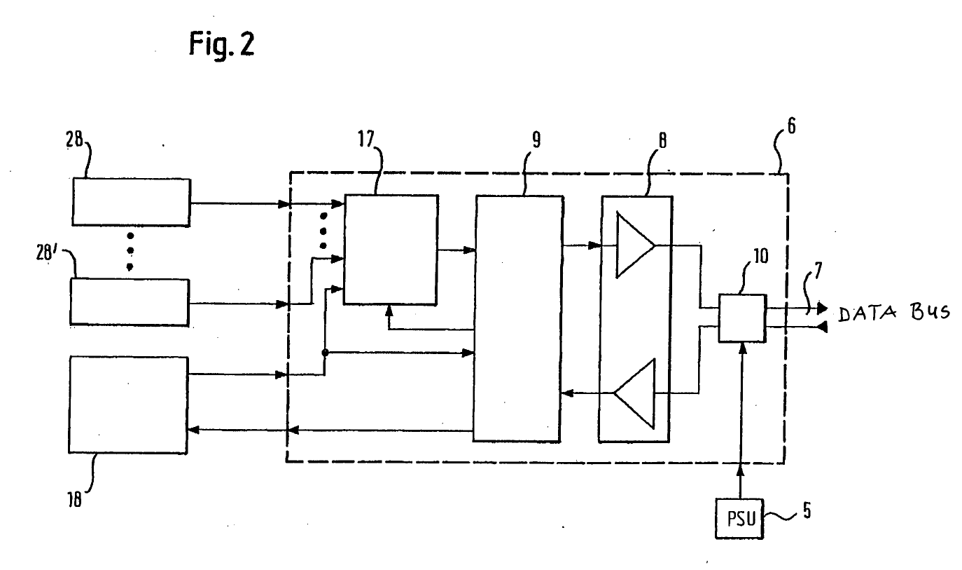

FIG. 2: a block schematic of a module (6) in the central unit (2);

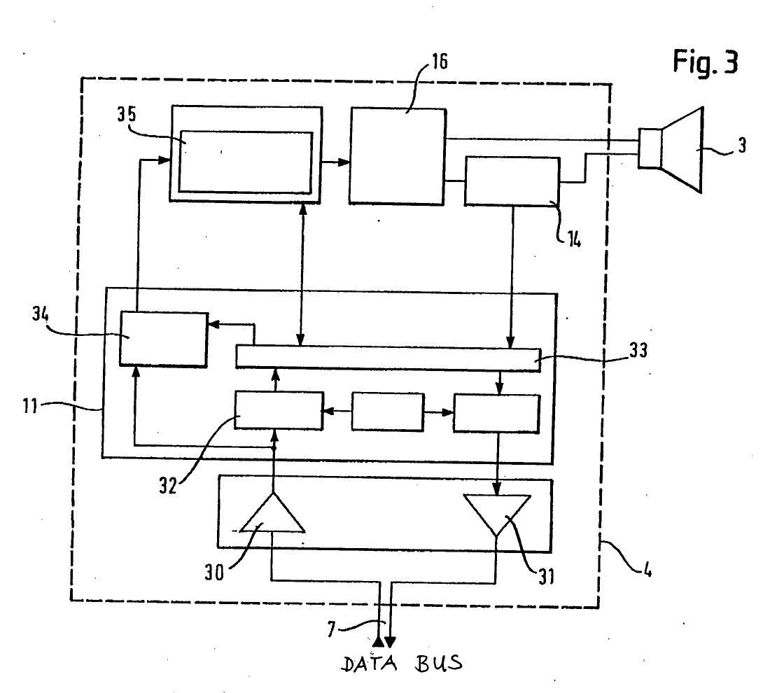

FIG. 3: a block schematic of the loudspeaker unit (4) having a loudspeaker (3);

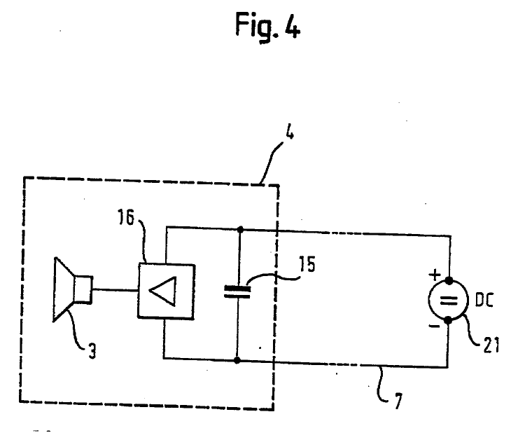

FIG. 4: a fundamental schematic of the loudspeaker unit (4) that is connected with a direct current source (21).

FIG. 1 shows a fundamental block schematic that represents the audio and control system 1 according to the invention. In the central unit 2, the audio data, control data from a processor, generally a PC 18, as well as the voltage supply, are brought together in an interface 6 and applied to the data buses 7. The central unit can have a data memory 2′, not shown here, in which audio data are stored. The stored data in the data memory 2′ are controlled by a processor 18 and passed to the related components, such as the loudspeaker unit 4, for example. The loudspeaker unit 4 has an amplifier 22, in each instance, which is connected with the central unit 2 by way of a data bus 7, 7′ or in wireless manner, whereby the number of loudspeaker units 4 can assume a predetermined number from 1 to n, and n can be any desired number. These units are described in greater detail below. The central unit 2 can transmit its data both in wireless manner by way of an antenna 24, as well as by way of hard-wired lines 25, such as a telephone line, for example. In this connection, it is important and advantageous to monitor the entire signal flow, for which purpose a high-frequency signal is transmitted along with the data flow, which signal lies outside the human hearing range and monitors the function of all the components in the signal flow, such as the signal processor 5, the end stage 22 of the loudspeaker and, in particular, the loudspeakers 3.

FIG. 2 shows a concrete block schematic of the module 6, which is responsible for the selection of the data coming into the central unit 2. A personal computer (PC) 18 is connected with the module 6 for control and monitoring of the entire system. The personal computer (PC) 18 assigns the control data to the time multiplexer 17, which furthermore receives audio data digitally from various sources 28, 28′, whereby the number of sources can be any desired number. Furthermore, the personal computer 18 is connected with the data extraction 9 of the module 6, so that the control data that come from the data bus of the control device 9 can be processed and handled in the PC. The data that come into the control device 9 from the time multiplexer 17 are processed in the data bus format here, and then passed to a data bus driver 8. The data bus driver 8 applies the received and processed data to the bi-directional data bus 7, in which these data are passed on to the loudspeaker units 4 for further processing. Furthermore, the individual units 4 and the entire control electronics are monitored using a high-frequency signal that is transmitted with the data, which lies outside of the human hearing range, and is passed to the personal computer 18 for further processing of the monitoring data, by way of the data driver 8 and the control unit 9. The PSU 5 is connected with the data bus 7 by way of an interface 10. The power of the power supply is transmitted to the data bus by means of the interface 10, i.e. it is modulated on, whereby the modulation is performed using a commercial modulation device.

FIG. 3 shows the block schematic of the loudspeaker unit 4 with its individual important components, in a block schematic. The bi-directional data bus 7 transmits not only the audio data for the loudspeaker 3, but also the energy needed to supply the individual units, in the form of a low voltage of U<48 volts, whereby the data flows in the data bus 7 are modulated onto the supply voltage (U). Each loudspeaker unit 4 contains an input driver and an output driver 30, 31, in each instance, by way of which the data are passed to and taken from the control unit 11. The incoming data reach an address decoder 32, which decodes the addresses that are carried along and passes them to the data control 33, if the address corresponds to the set address of the unit 4. The data control 33 assigns the audio data selected in accordance with the audio data selection 34 to a DSP 35, which then passes the processed data to a digital power amplifier 16, in which the digital signal is converted to an analog signal. The analog signal is directly passed to the loudspeaker 3, in analog manner, from the digital amplifier 16 in which the D/A conversion is carried out. In addition, the analog signal is passed to loudspeaker and switching electronics 14 and monitored, whereby reliable control is guaranteed, and the function of the loudspeaker and the control electronics is monitored and then the result is reported to the control device 33.

FIG. 4 shows a fundamental schematic that reproduces the basic elements of the loudspeaker unit 4, which is connected with a direct voltage source 21 by way of the bi-directional data bus 7. The two lines shown are an integral part of the data bus 7, which supplies both the supply voltage of U<48 volts and transmits the data modulated onto the supply voltage (U). Each loudspeaker unit 4 comprises at least one capacitor 15, which is switched in parallel with the supply of the digital amplifier 16 of the loudspeaker 3, so that in the case of a power peak, the corresponding excess power can be taken from the capacitor 15. The loudspeaker 3 is connected to the digital amplifier 16 and the D/A converter that performs the conversion of the digital data to analog signals. By means of such a switching arrangement, the data transmission is modulated onto the supply voltage, and therefore no additional supply voltage line is required, and a peak attenuation capacitor 15 is switched in parallel with the end stage 16, thereby allowing a constant transmission of the average power. Since the typical audio signals of the peak value of the power lie higher than the average value by a factor of approximately 8, the line cross-section can be designed to be clearly less, by means of the support capacitor 15, since the peaks are compensated by the capacitor 15.

Because of the fact that, in the case of the present invention, a significant component is the loudspeaker unit 4, which is directly attached to the loudspeaker 3 and selects incoming digital signals from a data bus 7, processes them digitally, if necessary, and then converts them into analog audio signals in a form such that a loudspeaker 3, as it is typically used in electro-acoustical systems, can be operated directly by means of the device, the status of the audio signals of each individual loudspeaker is individually influenced, without interference, in on-going operation. By means of the additional switching electronics 14 which, as mentioned, monitor the status of the loudspeaker and the entire switching electronics, and report this status to the central data storage unit 2 by way of a data bus 7, as well as another control device that evaluates incoming control signals individually for each loudspeaker 3, it is possible, for any desired number of loudspeaker units 4 having different audio signals and control signals, by means of a common data bus 7, to influence each loudspeaker unit 4 individually and without problems.

Furthermore, it is possible, on the basis of the present invention, to permanently check proper functioning, by means of monitoring the status of the loudspeaker and the switching electronics of the loudspeaker 3.

1. Method for transmitting, receiving, and processing audio signals of an information system (1), consisting of
a central unit (2) that receives, transmits, and controls signals digitally;
at least one loudspeaker unit (4) having at least one loudspeaker (3),
at least one bi-directional data bus (7),
wherein
a high-frequency signal is additionally transmitted with the data flow, which is used to monitor the function of all the connected components (2, 4, 8) of the system; and
the data flow in the data bus (7) is modulated onto the supply voltage.

2. Method according to claim 1, wherein the digital signals on the data bus (7) are selected in a module (6) in receiver-specific manner and processed for the specific receiver (4).

3. Method according to claim 1, wherein a first control device (9) of the module (6) handles inclusion of the audio and control data in the data bus format and/or monitors the extraction of data of the loudspeaker unit (4) and the switching electronics (9, 17) and transmits the status to the central unit (2).

4. Method according to claim 1, wherein a second control unit (11) is provided, which evaluates the incoming control signals from the data bus (7) in receiver-specific manner and converts them into receiver-specific signals.

5. Method according to claim 1, wherein a predetermined number of different audio signals and control signals is transmitted by means of a common bus (7).

6. Method according to claim 1, wherein the data are transmitted in wireless manner, and in data-compressed manner, by means of a bandwidth of approximately 15 kBaud.

7. Method according to claim 1, wherein the data format on the basis of RS 485 signals is used.

8. Method according to claim 1, wherein the signal flow is monitored all the way to the loudspeaker (3).

9. Method according to claim 1, wherein a high-frequency signal is transmitted in the data flow (audio signal), which lies outside of the human hearing range, and monitors the functions of all the components in the signal flow, such as the signal processor (13), the end stage (16) of the loudspeaker (3).

10. Method according to claim 1, wherein the control data are transmitted in real time.

11. Method according to claim 1, wherein the individual local loudspeaker units (4) are brought together in groups and that the volume of the individual loudspeakers (3) is automatically adjusted to the noise level of the surroundings, or adjusted by remote control.

12. Method according to claim 1, wherein the signals in the data bus (3) are transmitted at an average electric power and subjected to signal processing directly at the loudspeaker (3), in a single module (4), which produces high acoustical power and quality.

13. Audio system (1) for transmitting, receiving, and processing signals of an information system (1), consisting of
a central unit (2) that receives, transmits, and controls signals;
at least one loudspeaker unit (4) having at least one loudspeaker (3),
at least one data bus (7),
wherein
digital and/or analog signals are transmitted, received, and controlled;
all of the loudspeaker units (4) are supplied and controlled by the central data memory unit (2);
whereby the control data are modulated onto the supply voltage.

14. Audio system according to claim 13, wherein the loudspeaker unit (4) has at least one capacitor (15) switched in parallel with it on the input side.

15. Audio system according to claim 13, wherein the capacitance (C) and the voltage (U) of the capacitor (15) are sized in such a way that power peaks can be taken from the capacitor (15).

16. Audio system according to claim 13, wherein power amplification for the loudspeaker (3) operated in analog manner is carried out with a digital power amplifier (16).

17. Audio system according to claim 1, wherein the loudspeaker unit (4) arranged directly at the loudspeaker (3) selects the signals coming in from the data bus, processes them digitally, and converts them into analog signals.

18. Audio system according to claim 1, wherein a control device (11) that monitors the status of the loudspeaker unit (4) and the switching electronics, and transmits this status to the central unit (2) by way of a data bus (7).

19. Audio system according to claim 1, wherein a control device (9) that evaluates the control signals coming into the central unit (2) individually for each loudspeaker (3), and passes the results to a processor (18) (PC).

20. Audio system according to claim 1, wherein an interface (19) that transmits the audio control signals by way of a common bus (7), whereby a predetermined number of different signals is transmitted in the common bus (7).
